(19) United States
(12) Patent Application Publication
(10) Pub. No.: US 2019/0032757 A1
(43) Pub. Date: Jan. 31, 2019

(54) LINEAR EXTENSION AND RETRACTION MECHANISM AND ROBOT ARM MECHANISM

(71) Applicant: LIFE ROBOTICS INC., Tokyo (JP)

(72) Inventors: Woo-Keun YOON, Tokyo (JP); Hiroaki MATSUDA, Tokyo (JP)

(21) Appl. No.: 16/145,484

(22) Filed: Sep. 28, 2018

Related U.S. Application Data
(63) Continuation of application No. PCT/JP2017/012212, filed on Mar. 26, 2017.

(30) Foreign Application Priority Data
Mar. 29, 2016 (JP) 2016-066893

(51) Int. Cl. F16H 19/06; B25J 18/02; B25J 17/02; F16G 13/20

(52) U.S. Cl. CPC F16H 19/0663; B25J 18/025; F16G 13/20; F16H 19/0636; F16H 19/0645; B25J 17/0258

(57) ABSTRACT

A linear extension and retraction mechanism includes: a plurality of first pieces coupled together bendably; a plurality of second pieces coupled together bendably; a plurality of rollers adapted to join together the first pieces and the second pieces, forming a columnar body, and support the columnar body movably back and forth; a drive gear adapted to move the first pieces and the second pieces back and forth; and a motor unit adapted to generate power for rotating the drive gear. On a surface on a side where each of the first pieces is joined to a corresponding one of the second pieces, the first piece includes a linear gear to be meshed with the drive gear as well as a protrusion installed by protruding toward the second piece side. At least one third piece is bendably connected to a rearmost one of the plurality of first pieces.

### CROSS-REFERENCE TO RELATED APPLICATIONS

This application is a continuation application of International Patent Application No. PCT/JP2017/012212 filed on Mar. 26, 2017, which is based upon and claims the benefit of priority from the prior Japanese Patent Application No. 2016-066893, filed Mar. 29, 2016 the entire contents of which are incorporated herein by reference.

### FIELD

An embodiment described herein relates generally to a linear extension and retraction mechanism and a robot arm mechanism.

### BACKGROUND

Recently, the possibility has been considered of situations where, besides nursing care robots, an industrial robot performs operations in the vicinity of a worker. If such a situation is realized, a handicapped person may be able to work in the same manner as a healthy person with the support of the robot, for example. A vertical articulated robot arm mechanism put to practical use by the inventors and provided with a linear extension and retraction mechanism has no elbow joint and thus no singular points. Consequently, there is no possibility of the robot arm mechanism suddenly moving in an unexpected direction at high speed, and the movement of an arm and an end effector can be predicted. Accordingly, the robot arm mechanism has extremely high safety, thus making a safety fence unnecessary and realizing collaborative work between a robot and a worker.

The linear extension and retraction mechanism includes a plurality of pieces shaped like flat plates and coupled together bendably, and a plurality of pieces formed into C-shaped grooves and similarly coupled together bendably on a bottom surface side. The two types of pieces are joined together by being pressed firmly against each other by a roller unit. Consequently, the two types of pieces are stiffened linearly, making up a columnar arm section having a certain degree of rigidity. Linear gears are provided on rear surfaces of the flat-plate pieces and meshed with a drive gear coupled to a motor. When the drive gear rotates forward, the arm section formed into a columnar body is sent forward from the roller unit, and when the drive gear rotates backward, the arm section is pulled backward. The two types of pieces are separated from each other behind the roller unit, being restored to a bent state. After being restored to a bent state, the two types of pieces are bent in a same direction and housed in a column. A wrist section is attached to a tip of the arm section. The wrist section is equipped with three joint sections provided with three orthogonal axes of rotation to change a posture of an end effector as desired.

In this way, the linear extension and retraction mechanism needs many parts, and in particular, a large number of pieces of two types making up the arm section. These pieces are important parts whose production accuracy determines rigidity and linearity of the arm section. Therefore, a steep rise in the production cost of the linear extension and retraction mechanism is unavoidable.

### CITATION LIST

### Patent Literature

### [Patent Literature 1] Japanese Patent No. 5435679

### SUMMARY OF INVENTION

### Technical Problem

A purpose of the present invention is to reduce production costs of a linear extension and retraction mechanism and a robot arm mechanism.

### Solution to Problem

A linear extension and retraction mechanism according to the present embodiment includes: a plurality of first pieces shaped like a plate and coupled bendably with one another; and a plurality of second pieces C-shaped or hollow square-shaped in transverse section and coupled bendably with one another on a bottom surface side. When the first pieces are joined to the second pieces on a front surface side opposite the bottom surface side, the first pieces and the second pieces are formed into a columnar body stiffened by being restrained from bending. The first pieces and the second pieces return to a bent state when separated from each other. The mechanism includes a plurality of rollers adapted to join together the first pieces and second pieces, forming the columnar body, and support the columnar body movably back and forth, a drive gear adapted to send out the first pieces and the second pieces forward from the plurality of rollers and pull back the first pieces and the second pieces backward, and a motor unit adapted to generate power for rotating the drive gear. Each of the first pieces has a linear gear to be meshed with a corresponding one of the second pieces on a surface on a side joined to the second piece and the first piece and the second piece are provided with a lock mechanism to remain joined together. The lock mechanism includes a protrusion installed by protruding from the surface on the side on which each of the first pieces is joined to the second piece, and pinching sections provided on a front part and rear part of each of the second pieces, where the pinching sections on preceding and following second pieces pinch the protrusion of the first piece when the second piece is joined to the first piece, and release the protrusion of the first piece when the second piece is separated from the first piece. At least one third piece is bendably connected to a rearmost one of the plurality of first pieces.

### BRIEF DESCRIPTION OF THE VIEWS OF THE DRAWING

FIG. 1 is a perspective view illustrating an external appearance of a robot arm mechanism provided with a linear extension and retraction mechanism according the present embodiment.

FIG. 2 is a side view of the robot arm mechanism of FIG. 1.

FIG. 3 is a side view illustrating an internal structure of the robot arm mechanism of FIG. 1.

FIG. 4 is a perspective view of a tail of an arm section of FIG. 1.

FIG. 5 is a diagram illustrating a configuration of the robot arm mechanism of FIG. 1 using symbolic description.

FIGS. 6A, 6B, and 6C are diagrams illustrating a first piece of FIG. 4.

FIGS. 7A, 7B, and 7C are diagrams illustrating a second piece of FIG. 4.

FIGS. 8A, 8B, 8C, and 8D are diagrams illustrating a third piece of FIG. 4.

FIG. 9 is a side view illustrating how a mechanical stopper comes into play when stopper pins of the third piece of FIG. 8 abut a rear end face of a delivery mechanism.

FIG. 10 is diagram illustrating a variation of the third piece of FIG. 4.

FIG. 11 is diagram illustrating a variation of the third piece of FIG. 4.

### DETAILED DESCRIPTION

A linear extension and retraction mechanism according to the present embodiment is described below with reference to drawings. Note that the linear extension and retraction mechanism according to the present embodiment can be used as an independent mechanism (joint). Hereinafter, a robot arm mechanism in which one of a plurality of joint sections is made up of the linear extension and retraction mechanism according to the present embodiment is described as an example. A vertical articulated robot arm mechanism provided with the linear extension and retraction mechanism is described herein as an example of the robot arm mechanism, but the robot arm mechanism may be of another type. In the following description, components having substantially same functions and configurations are denoted by the same reference numerals, and redundant description thereof will be omitted unless necessary.

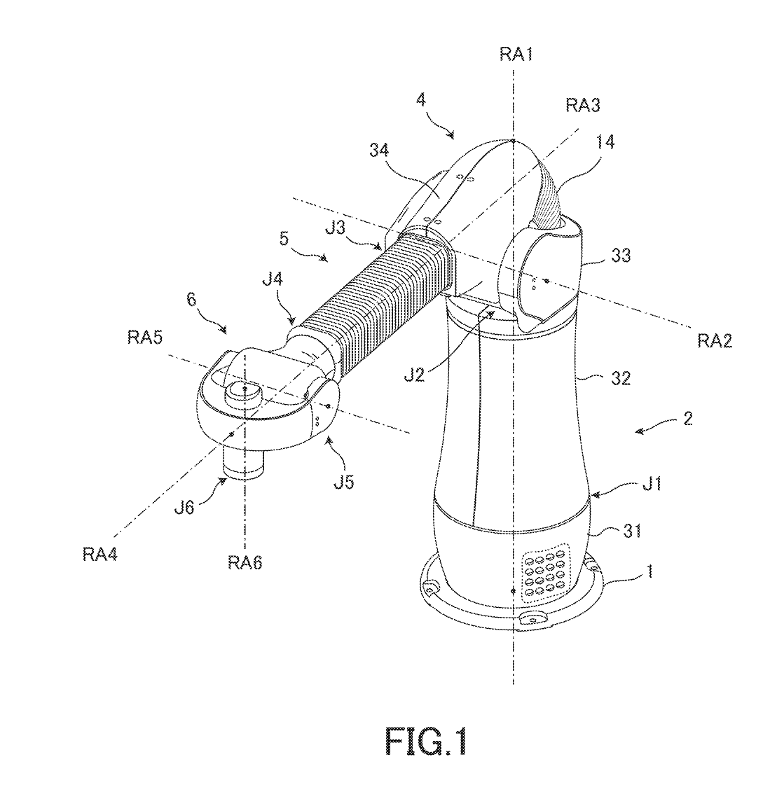

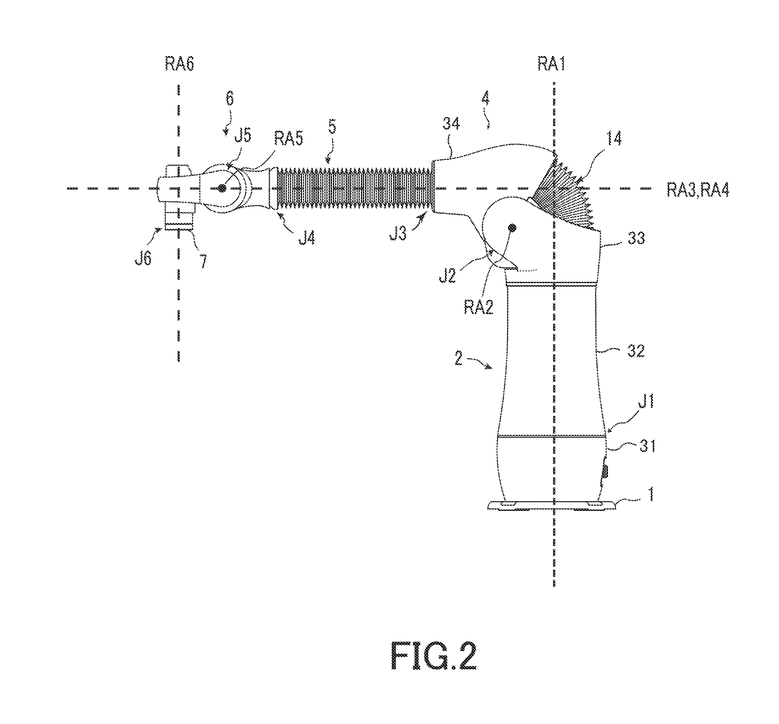

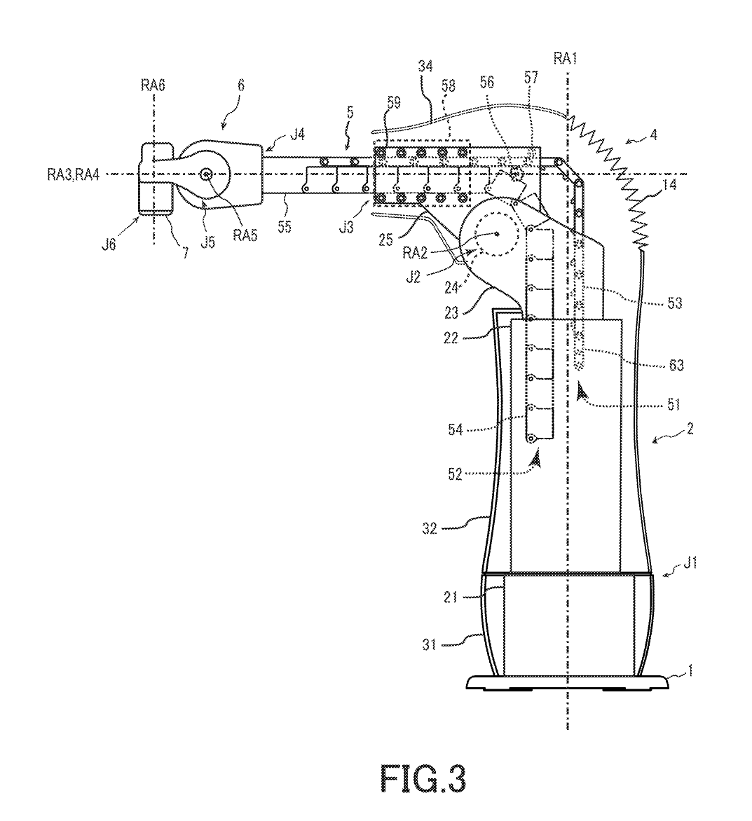

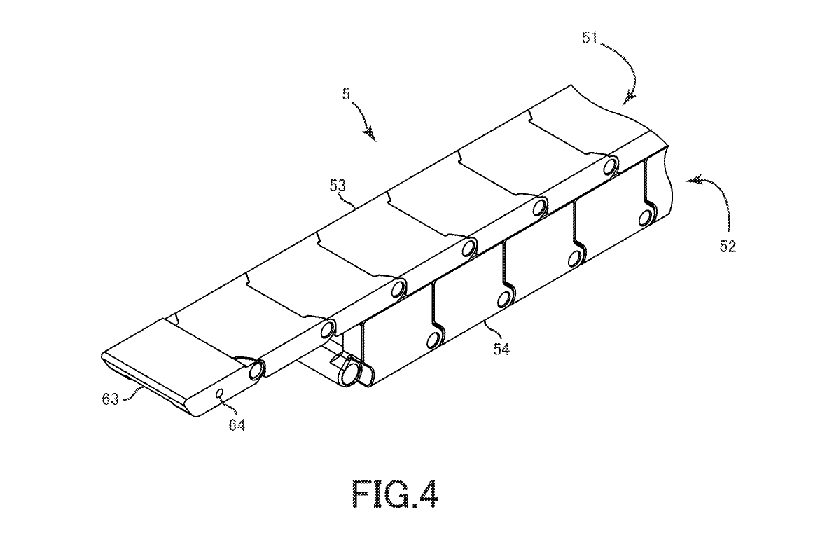

FIG. 1 illustrates an external appearance of a robot arm mechanism provided with the linear extension and retraction mechanism according the present embodiment. FIG. 2 is a side view of the robot arm mechanism of FIG. 1. FIG. 3 is a side view illustrating an internal structure of the robot arm mechanism of FIG. 1. FIG. 4 is a rear perspective view of an arm section 5 of FIG. 3.

The robot arm mechanism includes a base 1, a turning section (column) 2, an upwardly-and-downwardly moving section 4, an arm section 5, and a wrist section 6. The turning section 2, the upwardly-and-downwardly moving section 4, the arm section 5, and the wrist section 6 are arranged in order from the base 1. A plurality of joint sections J1, J2, J3, J4, J5, and J6 are arranged in order from the base 1. The turning section 2 forming a cylindrical body is installed typically vertically on the base 1. The turning section 2 houses the first joint section J1 serving as a turn rotation joint section. The first joint section J1 has a torsional rotation axis RA1. The axis of rotation RA1 is parallel to a vertical direction. The turning section 2 includes a lower frame 21 and an upper frame 22. The lower frame 21 is connected at one end with a fixed section of the first joint section J1. The lower frame 21 is connected at another end to the base 1. The lower frame 21 is covered by a housing 31 having a cylindrical shape. The upper frame 22 is connected to a rotating section of the first joint section J1, and axially rotates about the axis of rotation RA1. The upper frame 22 is covered by a housing 32 having a cylindrical shape. Along with the rotation of the first joint section J1, the upper frame 22 rotates with respect to the lower frame 21, thereby causing the arm section 5 to sweep horizontally. First and second piece strings 51 and 52 of the third joint section J3 are stored in an inner space of the turning section 2 forming a cylindrical body, where the first and second piece strings 51 and 52 serve as a linear extension and retraction mechanism described later.

The upwardly-and-downwardly moving section 4 adapted to house the second joint section J2 serving as a swivel joint section is installed on upper part the turning section 2. The second joint section J2 is a bending rotation joint. An axis of rotation RA2 of the second joint section J2 is perpendicular to the axis of rotation RA1. The upwardly-and-downwardly moving section 4 has a pair of side frames 23 as fixing sections (support sections) for the second joint section J2. The pair of side frames 23 are coupled to the upper frame 22. The pair of side frames 23 are covered by a cover 33 shaped like a saddle. A cylindrical body 24 serving as a rotating section of the second joint section J2 that combines a motor housing is supported by the pair of side frames 23. A delivery mechanism 25 is attached to a circumferential surface of the cylindrical body 24. The delivery mechanism 25 is covered by a cover 34, cylindrical in shape. A gap between the saddle-shaped cover 33 and the cylindrical cover 34 is covered by a U-shaped bellows cover 14. U-shaped in cross section. The U-shaped bellows cover 14 extends and retracts by following up-and-down pivot motion of the second joint section J2. The delivery mechanism 25 holds a drive gear 56, a guide roller 57, and a roller unit 58. Along with axial rotation of the cylindrical body 24, the delivery mechanism 25 turns, and the arm section 5 supported by the delivery mechanism 25 pivots up and down.

The third joint section J3 is provided by the linear extension and retraction mechanism. The linear extension and retraction mechanism has a structure newly developed by the inventors and is clearly distinguished from a conventional, so-called linear motion joint in terms of the range of movement. The arm section 5 of the third joint section J3 is bendable, but when the arm section 5 is sent forward along a center axis (center axis of extension and retraction RA3) from the delivery mechanism 25 at the root of the arm section 5, bending is limited and linear rigidity is ensured. When pulled backward, the arm section 5 recovers bendability. The arm section 5 includes the first piece string 51 and second piece string 52. The first piece string 51 is made up of a plurality of first pieces 53 coupled together bendably. The first piece 53 is configured into a substantially flat-plate shape. The first pieces 53 are bendably coupled together at ends by hinge sections. The second piece string 52 is made up of a plurality of second pieces 54. The second piece 54 is configured into a trough-like body C-shaped in transverse section or a tubular body hollow square-shaped in transverse section. The second pieces 54 are bendably coupled together by hinge sections at ends of bottom plates. The bending of the second piece string 52 is limited at a position where end faces of side plates of the second pieces 54 abut each other. At this position the second piece string 52 is arranged linearly. A leading first piece 53 of the first piece string 51 and a leading second piece 54 of the second piece string 52 are connected with each other by a head piece 55. For example, the head piece 55 has a combined shape of the first piece 53 and the second piece 54. As illustrated in FIG. 4, at least one third piece 63 is bendably connected to the rearmost first piece 53 of the first piece string 51. Detailed structures of the first, second, and third pieces 53, 54, and 63 are described later.

When passing through the roller unit 58 of the delivery mechanism 25, the first and second piece strings 51 and 52 are joined together by being pressed against each other by rollers 59. As a result of the joining, the first and second piece strings 51 and 52 exhibit linear rigidity, forming the arm section 5, columnar in shape. The drive gear 56 is provided behind the roller unit 58 together with the guide roller 57. The drive gear 56 is connected to a non-illustrated motor unit. The motor unit generates power to rotate the drive gear 56. Although this will be described later, on a surface on an inner side of the first piece 53, i.e., at a center in a width direction of the surface on the side on which the first piece 53 is joined to the second piece 54, a linear gear 539 is formed along a coupling direction. When the plurality of first pieces 53 are lined up linearly, the successive linear gears 539 are connected linearly, making up a long linear gear. The drive gear 56 is meshed with the linear gears 539 of the first pieces 53 pressed by the guide roller 57. The linearly connected linear gears 539 make up a rack-and-pinion mechanism in conjunction with the drive gear 56. When the drive gear 56 rotates forward, the first and second piece strings 51 and 52 are sent forward from the roller unit 58. When the drive gear 56 rotates backward, the first and second piece strings 51 and 52 are pulled backward of the roller unit 58. When pulled back, the first and second piece strings 51 and 52 are separated from each other at a location between the roller unit 58 and the drive gear 56. The separated first and second piece strings 51 and 52 are returned to a bendable state. After returning to a bendable state, the first and second piece strings 51 and 52 bend in a same direction (inward) and are stored vertically in the turning section 2. In so doing, the first piece string 51 is stored by being almost aligned substantially parallel to the second piece string 52.

A wrist section 6 is attached to a tip of the arm section 5. The wrist section 6 is equipped with the fourth to sixth joint sections J4 to J6. The fourth to sixth joint sections J4 to J6 have respective axes of rotation RA4 to RAG, which make up three orthogonal axes. The fourth joint section J4 is a torsional rotation joint around the fourth axis of rotation RA4, which substantially coincides with the center axis of extension and retraction RA3, and the end effector swings along with rotation of the fourth joint section J4. The fifth joint section J5 is a bending rotation joint around the fifth axis of rotation RA5 placed perpendicularly to the fourth axis of rotation RA4, and the end effector rotates to tilt back and forth along with rotation of the fifth joint section J5. The sixth joint section J6 is a torsional rotation joint around the sixth axis of rotation RA6 placed perpendicularly to the fourth axis of rotation RA4 and fifth axis of rotation RA5, and the end effector rotates axially along with rotation of the sixth joint section J6.

The end effector is attached to an adapter 7 provided in lower part of a rotating section of the sixth joint section J6 of the wrist section 6. The end effector is that part of the robot which has a function to work directly on a workpiece, and various tools, such as a gripping section, a vacuum suction section, a nut fastening tool, a welding gun, and a spray gun, are available for the end effector according to tasks. The end effector is moved to any desired position by the first, second, and third joint sections J1, J2, and J3, and placed in any desired posture by the fourth, fifth, and sixth joint sections J4, J5, and J6. In particular, length of an extension and retraction distance of the arm section 5 of the third joint section J3 allows the end effector to reach an object in a wide range from a position close to the base 1 to a position far from the base 1. The third joint section J3 is distinguished from the conventional linear motion joint by the linear extension and retraction motion realized by the linear extension and retraction mechanism of the third joint section J3 and the length of the extension and retraction distance.

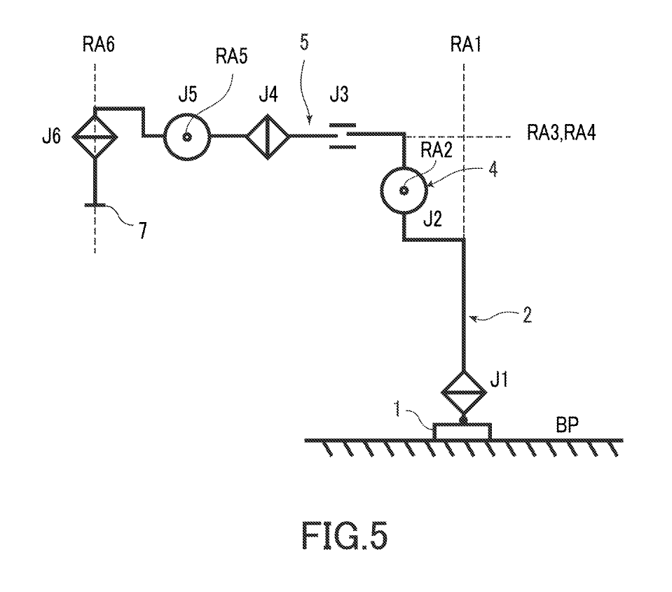

FIG. 5 illustrates a configuration of the robot arm mechanism using symbolic description. In the robot arm mechanism, three positional degrees of freedom are realized by the first joint section J1, second joint section J2, and third joint section J3 making up three root axes. Also, three postural degrees of freedom are realized by the fourth joint section J4, fifth joint section J5, and sixth joint section J6 making up three wrist axes. As illustrated in FIG. 5, the axis of rotation RA1 of the first joint section J1 is oriented in a vertical direction. The axis of rotation RA2 of the second joint section J2 is oriented in a horizontal direction. The second joint section J2 is offset from the first joint section J1 in two directions: a direction of the axis of rotation RA1 and a direction of an axis orthogonal to the axis of rotation RA1. The axis of rotation RA2 of the second joint section J2 does not intersect the axis of rotation RA2 of the first joint section J1. The axis of movement RA3 of the third joint section J3 is oriented in a direction perpendicular to the axis of rotation RA2. The third joint section J3 is offset from the second joint section J2 in two directions: the direction of the axis of rotation RA1 and a direction of an axis orthogonal to the axis of rotation RA1. The axis of rotation RA3 of the third joint section J3 does not intersect the axis of rotation RA2 of the second joint section J2. Since one bending joint section of the three root axes of the plurality of joint sections J1 to J6 is replaced with a linear extension and retraction joint section J3 and the second joint section J2 is offset from the first joint section J1 in two directions and the third joint section J3 is offset from the second joint section J2 in two directions, the robot arm mechanism of a robot device according to the present embodiment structurally eliminates singular postures.

(First Piece 53)

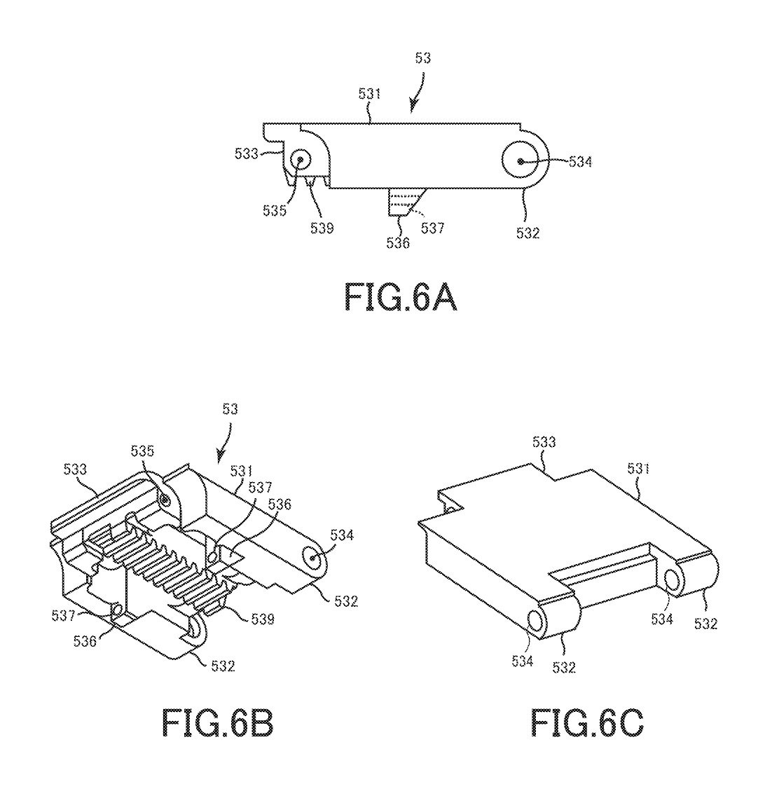

FIGS. 6A to 6C are diagrams illustrating a structure of the first piece 53 of FIG. 4. The first piece 53 is substantially a flat-plate body as a whole. The first piece 53 is made up of a flat plate rectangular main body 531 on which a pair of support blocks 532 and a bearing block 533 are formed integrally. The pair of support blocks 532 are provided on opposite sides on a front end of the main body 531, projecting forward. The bearing block 533 is provided in a center on a rear end of the main body 531, projecting rearward. The pair of support blocks 532 on the front end are penetrated by a pair of shaft holes 534 extending in parallel to a width direction of the first piece 53. The bearing block 533 on the rear end is also penetrated by a shaft hole 535 extending in parallel to the width direction of the first piece 53. When the bearing block 533 on the rear end of the first piece 53 is fitted between the pair of support blocks 532 on the front end of another first piece 53, the pair of shaft holes 534 and the shaft hole 535 are connected continuously. A non-illustrated shaft is inserted into the through-holes connected continuously, and consequently the preceding and following first pieces 53 are coupled together rotatably. In a center of a back face of the first piece 53 in the width direction, the linear gear 539 is provided across the first piece 53 in parallel to a coupling direction (length direction). Together with the linear gear 539, a pair of protrusions (pin hole blocks) 536 in a truncated square pyramid shape are provided on the back face of the first piece 53, projecting perpendicularly from the back face. The pair of pin hole blocks 536 are located on opposite sides near a longitudinal center of the first piece 53. In a center of each pin hole block 536 in a thickness direction, a lock pin hole 537 is formed in parallel to the coupling direction. The pin hole blocks 536 make up a lock mechanism in conjunction with chuck blocks 548 and lock pin blocks 546 of the second piece 54 described later, to keep the first and second pieces 53 and 54 joined together firmly. Details of the lock mechanism are described later.

(Second Piece 54)

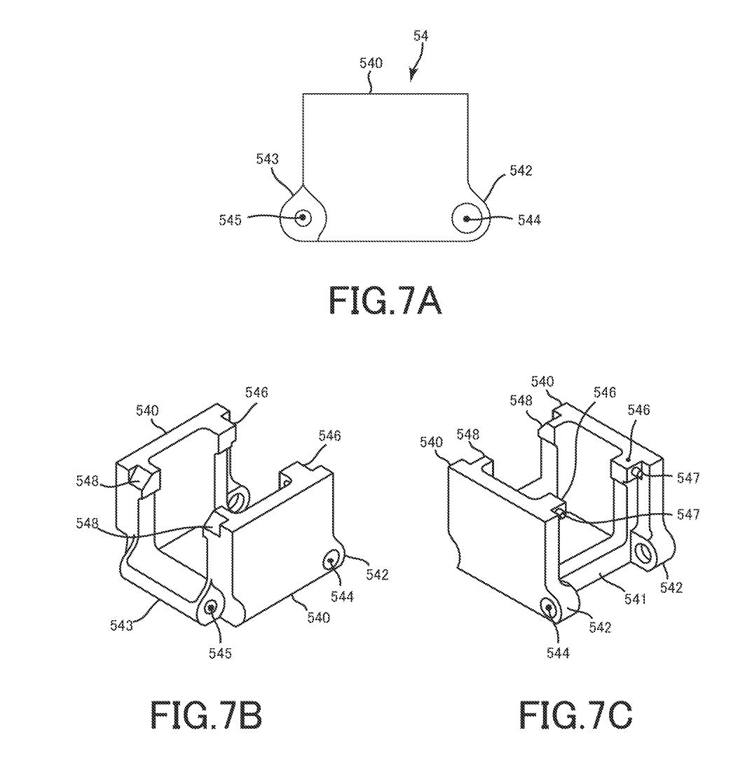

FIGS. 7A to 7C are diagrams illustrating a structure of the second piece 54 of FIG. 4. The second piece 54 is a trough-like body C-shaped in cross section or a tubular body hollow square-shaped in cross section as a whole. Here, it is assumed that the second piece 54 is a trough-like body, C-shaped in cross section. The second piece 54 is made up of a bottom plate 541, and a pair of side plates 540 equal in size and shape. A pair of support blocks 542 are installed on opposite sides on a front end of the bottom plate 541 by protruding therefrom. A bearing block 543 is installed in a center on a rear end of the bottom plate 541 by protruding therefrom. The pair of support blocks 542 on the front end are penetrated by a pair of shaft holes 544 extending in parallel to a width direction of the second piece 54. The bearing block 543 on the rear end is also penetrated by a shaft hole 545 extending in parallel to the width direction of the second piece 54. When the bearing block 543 on the rear end of the second piece 54 is fitted between the pair of support blocks 542 on the front end of another second piece 54, the pair of shaft holes 544 and the shaft hole 545 are connected continuously. A shaft is inserted into the through-holes connected continuously, and consequently the preceding and following second pieces 54 are coupled together rotatably. The lock pin block 546 is installed on upper part of the front end of each side plate 540 of the second piece 54 by protruding inward. The chuck block 548 is installed on upper part of the rear end of each side plate 540 of the second piece 54 by protruding inward. The lock pin block 546 is shaped as a rectangular parallelepiped, and a lock pin 547, columnar in shape, is provided on a front end face of the lock pin block 546 in parallel to the coupling direction. The chuck block 548 has a truncated square pyramid shape and an inclined surface of the chuck block 548 faces rearward. Of the preceding and following second pieces 54, the chuck block 548 of the preceding second piece 54 and the lock pin block 546 of the following second piece 54 make up a pinching section adapted to pinch the pin hole blocks 536.

(Lock Mechanism)

The first and second pieces 53 and 54 have the lock mechanism to remain joined together. The lock mechanism is made up of the chuck blocks 548 and lock pin blocks 546 of the second piece 54 and the pin hole blocks 536 of the first piece 53.

When the arm section 5 extends, each pair of preceding and following second pieces 54 changes from a bent state to a linear state. In this process, the pin hole blocks 536 of the first piece 53 are pinched by the chuck blocks 548 and lock pin blocks 546 of the preceding and following second pieces 54. Furthermore, the lock pins 547 on the lock pin blocks 546 of the second piece 54 are inserted into the pin holes 537 in the first piece 53. Consequently, the first and second pieces 53 and 54 are kept joined together firmly. When the second piece 54 passes a rearmost roller 59 of the roller unit 58 and is lined up linearly with the preceding second piece 54, the lock pins 547 of the second piece 54 are inserted into the pin holes 537 in the first piece 53. A state in which the lock pins 547 of the second piece 54 are inserted into the pin holes 537 in the first piece 53 is maintained with the preceding and following second pieces 54 being lined up linearly. i.e., with a rear end portion of the arm section 5 being held firmly by the roller unit 58.

When the arm section 5 retracts, the second pieces 54 are returned to a bendable state behind the roller unit 58 and pulled downward by gravity. On the other hand, the first pieces 53 are pulled backward by the drive gear 56 while maintaining a horizontal posture. While the second pieces 54 break away downward from the first pieces 53, each pair of preceding and following second pieces 54 changes from a linear state to a bent state. In this process, the lock pins 547 of the second piece 54 come out of the pin holes 537 in the first piece 53. The chuck blocks 548 and lock pin blocks 546 of the preceding and following second pieces 54 release the pin hole blocks 536 of the first piece 53, thereby causing the first and second pieces 53 and 54 to come out of the joined state and separate from each other.

(Third Piece 63)

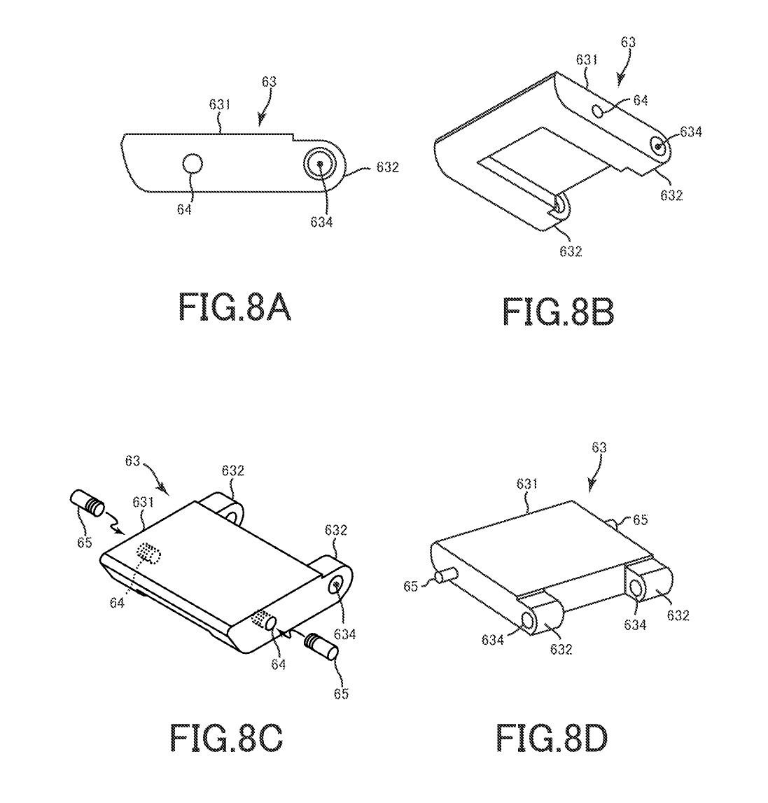

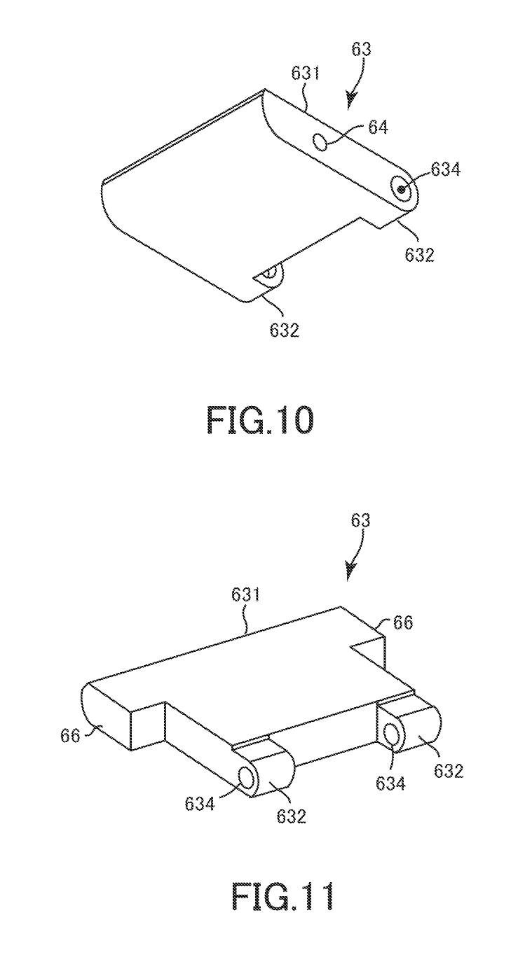

FIGS. 8A to 8D are diagrams illustrating a structure of the third piece 63 of FIG. 4. The third piece 63 is substantially identical in external shape to the first piece 53, but does not have the linear gear 539 and protrusions 536 of the first piece 53. The third piece 63 is substantially a flat-plate body as a whole. The third piece 63 includes a flat plate rectangular main body 631 and a pair of support blocks 632. A front face of the main body 631 is flat, but a back face is not flat. Edges thicker than a center portion of the plate are formed on opposite sides and on a rear end, and the center portion of the plate is depressed. However, as illustrated in FIG. 10, both the front face and back face of the main body 631 may be flat. The pair of support blocks 632 are provided by being spaced away to opposite sides of a front end of the main body 631 and projecting forward. That both the front face and back face of the main body 631 of the third piece 63 are flat falls under the category of the third piece 63 and especially its main body 631 being substantially identical in external shape to the first piece 53. The essence of the category of the third piece 63 and especially its main body 631 being substantially identical in external shape to the first piece 53 lies in that the third piece 63 does not have the linear gear and protrusions provided on the first piece 53.

The pair of support blocks 632 are penetrated by a pair of shaft holes 634 extending in parallel to a width direction of the third piece 63. When the bearing block 533 on the rear end of the rearmost first piece 53 of the first piece string 51 is fitted between the pair of support blocks 632 on the front end of the third piece 63, the pair of shaft holes 634 and the shaft hole 535 are communicated with each other. When a shaft is inserted into the communicated through-holes 634 and 535, the third piece 63 is rotatably coupled to the rearmost first piece 53 of the first piece string 51. As a structure for inserting stopper pins 65, for example, a pair of screw holes 64 are formed in opposite side faces at a longitudinal center of the third piece 63. The stopper pins 65 are fixed to the screw holes 64 by projecting laterally.

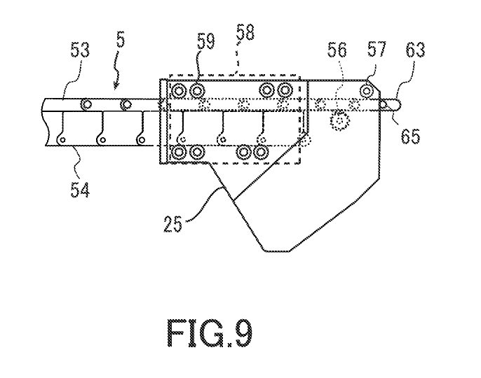

FIG. 9 is a side view illustrating how the stopper pins 65 of the third piece 63 of FIG. 8 abut a rear end face of the delivery mechanism 25. When the drive gear 56 rotates forward, sending out the first and second piece strings 51 and 52, and an extension distance of the third joint section J3 reaches a limit of the mechanical operating range, the stopper pins 65 provided on the third piece 63 abut the rear end face of the delivery mechanism 25. Consequently, any further extension movement of the third joint section J3 is restricted (mechanical stopper function). In the restricted state, the drive gear 56 and the linear gears 539 on the back face of the first pieces 53 are kept meshed together. In other words, the stopper pins 65 are provided at such positions on the third piece 63 as to maintain the meshed state. Note that depending on a distance between the drive gear 56 and the rear end face of the delivery mechanism 25, a plurality of the third pieces 63 may be coupled in line to the rearmost first piece 53 of the first piece string 51.

Note that instead of being provided with the stopper pins 65, as illustrated in FIG. 11, the third piece 63 may have a structure in which the main body 631 itself is shaped such that a rear portion juts out to both sides as stopper sections 66 by being made larger in width than a front portion. The stopper sections 66 abut the rear end face of the delivery mechanism 25, restricting any further extension movement of the third joint section J3.

The third piece 63 is substantially identical in external shape to the first piece 53. Specifically, the main body 631 of the third piece 63 is configured to be equal in width, substantially equal in thickness, and substantially equal in length to the main body 531 of the first piece 53. The main body 631 of the third piece 63 may be a little smaller or a little larger in thickness than the main body 531 of the first piece 53. Also, the main body 631 of the third piece 63 may be a little smaller or a little larger in length than the main body 531 of the first piece 53 depending on the distance between the drive gear 56 and the rear end face of the delivery mechanism 25 as long as bending between the column 2 of the first piece string 51 and the delivery mechanism 25 is not obstructed.

Making the third piece 63 substantially identical in external shape to the first piece 53 limits reduction of smoothness in sending out and pulling back the first piece string 51 even though the first piece string 51 is provided with the third piece 63.

The first piece 53 is equipped with the bearing block 533 on the rear end of the main body 531. In contrast, the third piece 63 is not equipped with a bearing block on a rear end of the main body 631. The first piece 53 is equipped with the pair of support blocks 532 on both sides of the front end of the main body 531. Similarly, the third piece 63 is equipped with a pair of support blocks 632 on the front end of the main body 631.

The first and second pieces 53 and 54 are required to have high rigidity and high surface hardness in order to withstand a pressing force exerted by the roller unit 58 adapted to support the arm section 5 from above, below, left, and right. Therefore, the first and second pieces 53 and 54 are made of metal, and typically aluminum, which combines hardness and formability, and furthermore, surface treatment such as hard anodizing treatment is applied to surfaces of the first and second pieces 53 to increase hardness. On the other hand, the third piece 63, which is attached to the rearmost first piece 53 of the first piece string 51 to limit the extension distance of the third joint section J3 to within a mechanical operating range, can only move to just before reaching the drive gear 56. Therefore, the third piece 63 is neither meshed with the drive gear 56 nor pressed by the roller unit 58. Thus, the third piece 63 does not need to have such rigidity and surface hardness as the first piece 53. Consequently, the third piece 63 is produced at lower cost using a material different from the first and second pieces 53 and 54, and specifically, a synthetic resin lower in hardness and easier to form than the first and second pieces 53 and 54. Of course, the third piece 63 may be produced using a different metal lower in hardness and easier to form than the metal of the first and second pieces 53 and 54.

The use of the third piece 63 contributes to keeping down the production cost of the pieces compared to when the first piece 53 is used as a stopper piece. Furthermore, there is no need for the third piece 63 to be equipped with the linear gear 539 and pin hole blocks 536 provided on the first piece 53. The fact that the third piece 63 is not equipped with any linear gear or pin hole block eliminates the need for complex machining of the pieces and contributes to keeping down the production cost of the pieces.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

53 . . . first piece, 54 . . . second piece, 63 . . . third piece, 64 . . . screw hole, 65 . . . stopper pin, 631 . . . main body, 632 . . . support blocks

1. A linear extension and retraction mechanism comprising:
a plurality of first pieces shaped like a flat plate and coupled bendably with one another;
a plurality of second pieces C-shaped or hollow square-shaped in transverse section and coupled bendably with one another on a bottom surface side, where the first pieces and the second pieces are formed into a columnar body stiffened by being restrained from bending when the first pieces are joined to the second pieces on a front surface side opposite the bottom surface side, and the first pieces and the second pieces return to a bent state when separated from each other;
a plurality of rollers adapted to join together the first pieces and the second pieces, forming the columnar body, and support the columnar body movably back and forth;
a drive gear adapted to send out the first pieces and the second pieces forward from the plurality of rollers and pull back the first pieces and the second pieces backward; and
a motor unit adapted to generate power for rotating the drive gear,
wherein each of the first pieces has a linear gear to be meshed with the drive gear on a surface on a side joined to the second piece,
the first piece and the second piece are provided with a lock mechanism to remain joined together,
the lock mechanism includes a protrusion installed by protruding from the surface on the side on which each of the first pieces is joined to the second piece, and pinching sections provided on a front part and rear part of each of the second pieces, where the pinching sections on preceding and following second pieces pinch the protrusion of the first piece when the second piece is joined to the first piece, and release the protrusion of the first piece when the second piece is separated from the first piece, and
at least one third piece is bendably connected to a rearmost one of the plurality of first pieces.

2. The linear extension and retraction mechanism according to claim 1, wherein the third piece is substantially identical in external shape to the first piece, but does not have the linear gear and the protrusion.

3. The linear extension and retraction mechanism according to claim 1, wherein:
the rollers and the drive gear are supported by a frame;
a stopper pin configured to project laterally is installed on the third piece, protruding therefrom; and
the stopper pin of the third piece abuts a trailing edge of the frame, thereby preventing the first pieces and the second pieces from falling out of the rollers and the drive gear.

4. The linear extension and retraction mechanism according to claim 1, wherein the third piece is made of a material different from the first pieces.

5. The linear extension and retraction mechanism according to claim 4, wherein the third piece is made of a synthetic resin.

6. The linear extension and retraction mechanism according to claim 5, wherein the first pieces are made of metal.

7. The linear extension and retraction mechanism according to claim 1, wherein:
the first pieces are coupled together by hinge sections, a first bearing block having a first bearing hole is provided on a rear end of each of the first pieces, projecting rearward, and a second bearing block having a second bearing hole and communicated with the first bearing hole is provided on a front end of each of the first pieces, projecting forward; and
a third bearing block having a third bearing hole is provided on a front end of the third piece by projecting forward, the third bearing hole being communicated with the second bearing holes of the first pieces, and no bearing block is provided on a rear end of the third piece.

8. A robot arm mechanism, in which a column equipped with a turn rotation joint section is supported on a base, an upwardly-and-downwardly moving section equipped with a swivel joint section is placed on the column, a linear extension and retraction mechanism equipped with an arm section configured to be linearly extendible and retractable is provided on the upwardly-and-downwardly moving section, the arm section is equipped at a tip with a wrist section fittable with an end effector, and the wrist section is equipped with at least one rotation joint section for changing a posture of the end effector, wherein:
the linear extension and retraction mechanism includes:
a plurality of first pieces shaped like a flat plate and coupled bendably with one another,
a plurality of second pieces C-shaped or hollow square-shaped in transverse section and coupled bendably with one another on a bottom surface side, where the first pieces and the second pieces are formed into a columnar body stiffened by being restrained from bending when the first pieces are joined to the second pieces on a front surface side opposite the bottom surface side, and the first pieces and the second pieces return to a bent state when separated from each other,
a plurality of rollers adapted to join together the first pieces and the second pieces, forming the columnar body, and support the columnar body movably back and forth,
a drive gear adapted to send out the first pieces and the second pieces forward from the plurality of rollers and pull back the first pieces and the second pieces backward, and
a motor unit adapted to generate power for rotating the drive gear;
each of the first pieces has a linear gear to be meshed with the drive gear on a surface on a side joined to the second piece;
the first piece and the second piece are provided with a lock mechanism to remain joined together;
the lock mechanism includes a protrusion installed by protruding from the surface on the side on which each of the first pieces is joined to the second piece, and pinching sections provided on a front part and rear part of each of the second pieces, where the pinching sections on preceding and following second pieces pinch the protrusion of the first piece when the second piece is joined to the first piece, and release the protrusion of the first piece when the second piece is separated from the first piece; and
at least one third piece is bendably connected to a rearmost one of the plurality of first pieces.

9. The robot arm mechanism according to claim 8, wherein the third piece is substantially identical in external shape to the first piece, but does not have the linear gear and the protrusion.
